(19) United States
(12) Patent Application Publication
(10) Pub. No.: US 2005/0273831 A1
(43) Pub. Date: Dec. 8, 2005

(54) Video monitoring system

(76) Inventors: Juda Slomovich, North Woodmere, NY (US); Yona Wieder, Newton, MA (US)

Correspondence Address: Iandiorio & Teska, 260 Bear Hill Road, Waltham, MA, 02451-1018, US

(21) Appl. No.: 10/860,338

(22) Filed: Jun. 3, 2004

(51) Int. Cl. H04N 7/18

(52) U.S. Cl. 725/105; 348/143; 375/240.01

(57) ABSTRACT

A video monitoring system for a plurality of sites. A site security system is located at each site and includes one or more video cameras each outputting a video signal and a processor configured to receive a video signal from each camera, detect predetermined events based on the video signal, generate a video alarm signal upon the detection of an event, transmit the video alarm signal to a central station, and establish a video signal link either with the central station or one of a plurality of satellite stations according to a predetermined protocol upon the transmission of a video alarm signal. A central station includes a router for routing any received video signal to one or more workstations and for routing the video alarm signal to a server configured to associate the video alarm signal with a particular satellite station and to forward the video alarm signal to that satellite station. The satellite station includes a workstation configured to receive the video alarm signal from the central station and to receive the video signal from the site security system.

### FIELD OF THE INVENTION

This invention relates to a video monitoring system including video event detection technology, a central station, and one or more satellite stations providing a less expensive and more secure monitoring solution for one or more customer sites with improved customer service.

### BACKGROUND OF THE INVENTION

Video security systems have long been used in connection with office buildings and other business sites in conjunction with other security devices such as make/break contacts on doors, fire alarms, and many other types of sensors. Typically, a guard station at the site includes video monitors connected to a number of video cameras and viewed by one or more guards and a control panel which provides an indication when a sensor indicates an alarm condition.

Employing full time guards is costly, however, and, in addition, guards can miss certain events on the video monitors due to distractions and/or fatigue. Thus, the idea of central control station was born whereby the video cameras and security devices at the site are linked to remote station where station employees monitor the security systems of a number of different sites. The personnel at the remote site, however, still have to continuously monitor the video monitors for each site. Also, the remote sites include costly equipment. Often, the central station is geographically remote from one or several of the sites. Also, should the central station fail, there is no back up subsystem for ensuring security at each site.

In an effort to reduce the demands on security personnel either at a given site or at a remote central control station, video event detection technology was designed. The basic idea is that security personnel need not continuously monitor the video monitors. Instead, a site control processor is programmed to automatically receive the video images from the video cameras and to automatically sound alarm only when one or more predetermined events are detected. U.S. Pat. No. 6,069,655, incorporated herein by this reference, for example, describes various object recognition products and ways to differentiate between human and non-human (animal) intruders. Only when the site control processor confirms the presence of an intruder is an alarm signal and a video signal sent to a remote operator who then examines the video and determines whether any action is required. In this way, a remote site with very few operators can more effectively and efficiently monitor a number of individual customer sites.

The equipment located at the central station and the central station itself, however, must be certified (e.g., UL certified) and also must be highly reliable. As such, central stations are costly. Also, some present day remote site video event detection systems do not take full advantage of the internet as the communication interface between the site and the control station. Other systems, for example, only begin video recording after an event is detected which means that the operator is unable to view the scene prior to the event.

In summary, the different technologies that are used today for behavior monitoring, access control, alarm detection, video compression, and the like are often complex and in most cases each technology was developed as a stand alone solution by a different entity and there is no natural connection and interface between all the current solutions. No prior art teaches seamless integration between all of the various technologies to operate together.

### SUMMARY OF THE INVENTION

It is therefore an object of this invention to provide a video security system with greatly improved customer service capabilities.

It is a further object of this invention to provide such a system which is less costly than prior art systems.

It is a further object of this invention to provide such a system which takes full advantage of the internet as a communication interface between the customer site and the remote site(s).

It is a further object of this invention to provide such a system which enables full time video recording allowing operators to view recorded digital video signals recorded prior to the detection of an event.

It is a further object of this invention to provide an intelligent automated threat detection security system.

It is a further object of this invention to provide such a system which provides real-time, automated transmission of any detected threat information (video, audio, data) on available networks to a central monitoring station.

It is a further object of this invention to provide an active central monitoring station that is able to receive and transmit in real time all types of available information pertaining to one or more sites and to disseminate the information in real time to designated security or law enforcement personnel.

The invention results from the realization that the service provided by remote monitoring security systems is greatly enhanced by the implementation of lower cost satellite stations each typically responsible for a few sites and each typically geographically proximate the customer site being monitored in combination with a processor at the site which feeds the video signal to the satellite station but transmits the alarm signals to a central station which, in turn, routes the alarm signal to the appropriate satellite station.

In this invention, central station operator has a seamless integrated solution. In addition, the advantage of the Internet as the communication interface between the site and the central station provides a distributed solution where satellite offices can be connected to the main central monitoring station without the need for setting up costly local central stations thus providing a high end solution at a reduced cost. The service provided by remote monitoring security system is greatly enhanced when various advanced detection technologies are integrated together to provide a seamless solution that can be used by a central station operator to analyze security threats at remote sites.

The subject invention, however, in other embodiments, need not achieve all these objectives and the claims hereof should not be limited to structures or methods capable of achieving these objectives.

This invention features a video monitoring system for a plurality of sites. A site security system is located at each site and includes one or more video cameras each outputting a video signal, and a processor configured to receive a video signal from each camera, detect predetermined events based on the video signal, generate a video alarm signal upon the detection of an event, transmit the video alarm signal to a central station, and establish a video signal link either with the central station or one of a plurality of satellite stations according to a predetermined protocol upon the transmission of a video alarm signal. The central station includes a router for routing any received video signal to one or more workstations and for routing the video alarm signal to a server configured to associate the video alarm signal with a said satellite station and to forward the video alarm signal to the satellite station. The satellite station includes a workstation configured to receive a video alarm signal from the central station and to receive a video signal from the site security system.

The typical site security system further includes a digital video recorder responsive to the video signal for recording the video signal and a video compression device for compressing the digital video signal. The workstations of the central station also include a video decompression device for decompressing the received video signal.

The site security system may further include one or more sensing devices connected to the processor and the processor is configured to generate an alarm signal in response to the sensing devices and to transmit the alarm signal to the central station server via the router. The site security system may further include an alarm system interconnected with the central station. An exemplary alarm system is configured to send predetermined alarm signals to the processor of the site security system for transmission to the central station. A typical site security system further includes one or more two-way speakers connected to the processor. The processor is then configured to transmit audio signals to the central station and the router of the central station is configured to route the audio signals to one or more of the workstations of the central station.

The preference is the processor of the site security system being configured to transmit the video alarm signal to the central station and to establish the video signal link according to an internet protocol. Additional data links may exist between the processor of the site security system and the central station.

The preferred central station includes an alarm receiver for receiving alarm signals and a signal processor responsive to the alarm receiver for associating alarm signals with particular sites. Typically, the workstations of the central station are connected to the router and the server by a network. One workstation may be configured as a supervisor station and programmed to route the video alarm signal and the video signal to another workstation based on availability. Another workstation may include a face recognition engine responsive to the video signal. Typically, selected workstations are configured to communicate with the site security system processor via the server of the central station to perform at least actions such as controlling a video camera, triggering a relay, communicating via a speaker and/or receiving a recorded video signals. The satellite station may be physically located at the site. More typically each satellite station is regionally associated with a plurality of sites.

The predetermined protocol may be to establish the video signal link with a satellite station during a first time period and to establish the video signal link with the central station during a second time period. Another predetermined protocol is to establish the video signal link with a satellite station unless said link cannot be established and to then in response establish the video signal link with the central station. Still another predetermined protocol is to establish the video signal link with the central station unless said link cannot be established and to then in response to establish the video signal link with the satellite station.

Typically, the central station is UL certified. A map of the site is preferably associated with the processor of the site security system and/or a workstation of the central station and/or a satellite station for pinpointing the location of a video alarm signal. The site security system may be mobile and even the satellite station may be mobile.

A video monitoring system for a plurality of sites in accordance with this invention features three interrelated communication channels. A site security system is located at each site and includes a processor configured to transmit video signals, alarm signals, video event signals, and audio signals. A central station includes at least one workstation. At least one satellite station also includes a workstation. The first communication channel is between the site security system processor and the central station workstation for transmitting alarm signals, video signals, video event signals, and audio signals from the site to the central station workstation. The second communication channel is between the site processor and the satellite station workstation for transmitting video signals from the site to the satellite station workstation. The third communication channel is between the central station and the satellite station for transmitting alarm signals and video event signals to the satellite station workstation. Each communication channel preferably includes the internet.

The first communication channel typically further includes one or more additional data links between the site and the central station. The central station workstation is typically configured to control the processor of the site security system via the first communication link and the satellite station workstation is typically also configured to control the processor of the site security system via the second communication channel.

One method of remotely monitoring a site includes receiving a video signal from cameras located at the site, detecting predetermined events based on the video signal, generating a video alarm signal upon the detection of an event, and transmitting the video alarm signal to a central station. A video signal link is established either with the central station or one of a plurality of satellite stations according to a predetermined protocol upon the transmission of a video alarm signal. Any received video signal is routed to one or more central station workstations and the video alarm signal is routed to a server configured to associate the video alarm signal with a satellite station and to forward the video alarm signal to the satellite station. The satellite station receives the video alarm signal from the central station and receives the video signal from the site.

Video signals are typically recorded and compressed at the site and decompressed at the central station and recorded. The site typically generates an alarm signal in response to sensing devices and transmits the alarm signal to the central station server. The site transmits audio signals to the central station and transmits the video alarm signal to the central station and establishes the video signal link according to an internet protocol.

One central station workstation may be configured as a supervisor station programmed to route the video alarm signal and the video signal to another workstation based on availability. One predetermined protocol is to establish the video signal link with a satellite station during a first time period and to establish the video signal link with the central station during a second time period. Another predetermined protocol is to establish the video signal link with a satellite station unless said link cannot be established and to then establish the video signal link with the central station. Still another predetermined protocol is to establish the video signal link with the central station unless said link cannot be established and to then establish the video signal link with the satellite station.

### BRIEF DESCRIPTION OF THE DRAWINGS

Other objects, features and advantages will occur to those skilled in the art from the following description of a preferred embodiment and the accompanying drawings, in which:

FIG. 1 is a block diagram of one prior art video security system;

FIG. 2 is a block diagram of a video security system in accordance with the subject invention;

FIG. 3 is a schematic view of a typical site security system in accordance with the subject invention;

FIG. 4 is a block diagram showing the configuration of a typical central station in accordance with the subject invention; and

FIG. 5 is a more complete block diagram showing the primary components associated with a central station and typical satellite stations in accordance with the subject invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

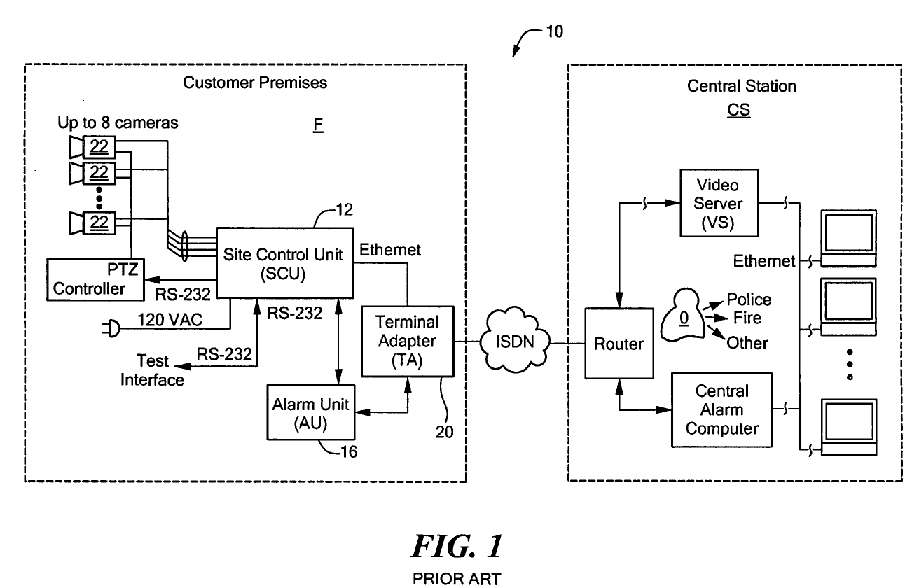

FIG. 1 depicts one state of the art video security system 10 as depicted in U.S. Pat. No. 6,069,655. The system informs operator O of the presence of an intruder at the facility F after detecting the intruder's presence and confirming the intruder is one of a designated class of intruders for which some action is to be taken. The system purports to differentiate between motion caused by human and non-humans (animal) and other lighting effects. Outputs from cameras 22 are routed to image acquisition means of site control unit (SCU) 12 which, in turn, is connected to alarm unit (AU) 16 and to terminal adapter (TA) 20. Window and door sensors and motion sensors are also connected to the alarm unit 20. The function of SCU 12 is to intelligently look at video acquired from each of the cameras to determine if an intruder is present within any of the scenes viewed by the cameras. If it is determined that this is so, SCU 12 sends an indication to AU 16. The function of AU 16 is to review the alarm indication and determine whether or not it should be reported to the central station. AU 16 then sends an alarm through TA 20 to the central station CS and commands SCU 12 to transmit its video also through TA 20 to the central station. Video is not ordinarily transmitted from the SCU to the central station unless the SCU and the AU determine that there is an adequate reason for operator O to invwstigate and even then, the video feed is not in real time. Instead, the video images of a scene are acquired in a sequential, multiple fashion.

When a sensor triggers an alarm, the system operator O can request visual verification of the alarm condition from the nearest camera controlled by the SCU. This allows the operator to visually verify or reject the alarm condition with the same result as if the indication had been triggered by the SCU. A control panel including a keypad may be located on the premise such that when the system is armed and someone enters the premises, the person can enter the appropriate code into the keypad no intrusion has occurred and hence no alarm condition is reported to the central station.

As delineated in the background section above, the different technologies that are used today for behavior monitoring, access control, alarm detection, video compression, and the like are often complex and in most cases each technology was developed as a stand alone solution by a different entity and there is no natural connection and interface between all the current solutions. No prior art teaches seamless integration between all of the various technologies to operate together. Currently available security video monitoring systems of this type suffer from the fact that one central station is responsible for many sites and the central station is thus typically geographically remote from one or more of the sites. Customers often have trouble dealing with geographically remote service providers and the level of service offered each customer site is diminished. Moreover, each central station is costly to set-up and maintain. Typically, the central station equipment and the central station itself must be certified. In addition, some present day remote site video event detection systems do not take full advantage of the internet as a communication interface between the site and the central station. Other systems only begin video recording after an event is detected which means that the operator is unable to view the scene prior to the event.

In this invention, central station operator has a seamless integrated solution. In addition, the advantage of the Internet as the communication interface between the site and the central station provides a distributed solution where satellite offices can be connected to the main central monitoring station without the need for setting up costly local central stations thus providing a high end solution at a reduced cost. The service provided by remote monitoring security system is greatly enhanced when various advanced detection technologies are integrated together to provide a seamless solution that can be used by a central station operator to analyze security threats at remote sites.

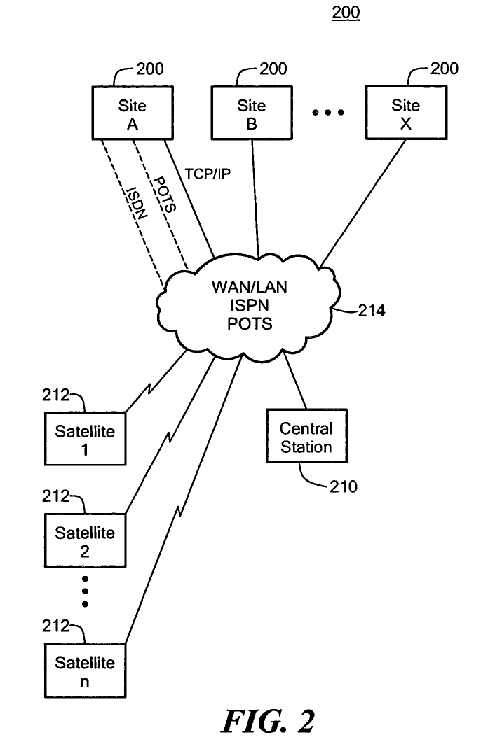

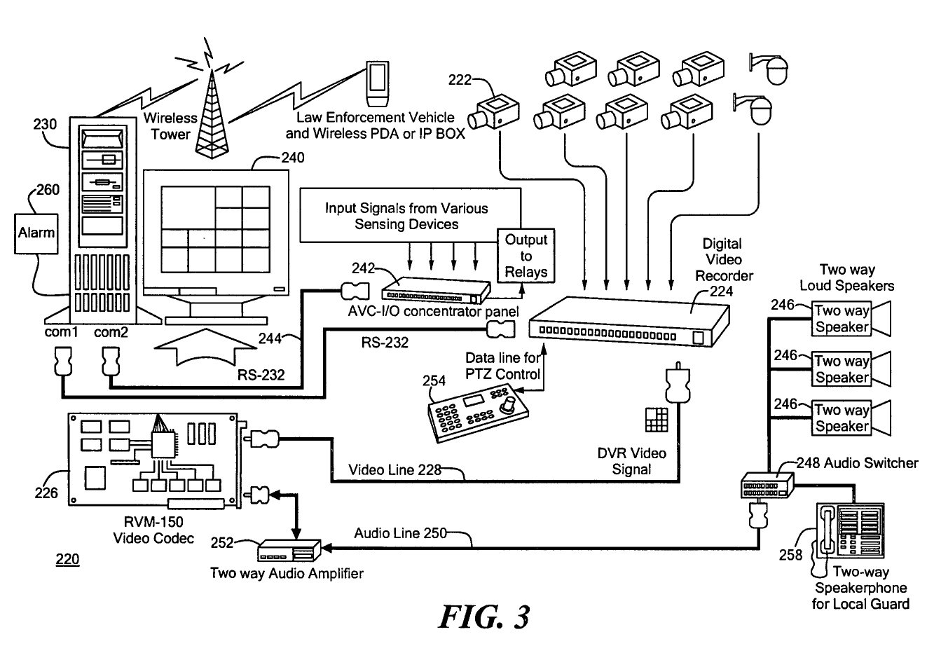

A typical video monitoring system in accordance with the subject invention includes customer sites 200, FIG. 2 each including a site security system discussed below with respect to FIG. 3. Central station 210 and satellite stations 212 communicate with customer sites 200 via network 214, preferably the internet. A video alarm signal based on video event detection programming at each site 200 is transmitted via network 214 to central station 210 which then logs the alarm and forwards it to the appropriate satellite station 212. The video signal itself corresponding to the video alarm signal is typically transmitted directly to the appropriate satellite station 212 via network 214.

In this way, the more expensive certified central station can be responsible for the management of many sites and perform record keeping, alarm event logging, and invoicing services for all the sites but the less expensive satellite stations are able to provide improved customer service duties when an alarm event at a site is communicated to the satellite station. Each satellite station is typically geographically proximate one or more sites to improve customer service in this way. For example, satellite station 1 and sites A and B may be all located in the northeast region of the United States while control station 210 may be located in California. Still, control station 210 is able to provide back up video monitoring services for a given satellite station when required. Moreover, a satellite station can provide back up services for the central station. One or more satellite stations can be mobile and temporarily placed at a site. In addition, the satellite stations allow a customer to share monitoring operations as, for example, the customer site provides the security services during normal business hours and the satellite station provides security services during off hours.

FIG. 3 describes an exemplary customer site security system 220. Video cameras 222 are positioned as appropriate to monitor key areas of a customer's premises and each provide a video signal to digital video recorder 224 which continuously records the video signals in order to playback video records for one or more cameras 222 prior to a detected event. The video signal from recorder 224 is connected to video codec 226 over video line 228. Codec 226 compresses the video signal for later processing by processor 230. Processor 230 preferably includes codec 226. Processor 230 receives the video signal from each camera 222 and includes video event detection software configured to detect predetermined events based on the video signal. Suitable commercially available video even detection software includes the products available from MATE (preferred), Object Video, Cernium, and GE Security. Behavior analysis software may also be implemented to continuously analyze all video streams for predetermined alarm patterns. The video event detection software may target events such as line crossing where a target has moved from one side of a user-specified line to the other side, a line violation where a target is on the wrong side of a line, a line intersection where a target intersects the line, entry-exit events where a target has completed a path from an entry point to an exit point, a directional motion event wherein a target is moving in a range of user specified directions, a high speed alarm mode where a target is traveling at a speed above a user-defined threshold, stop target mode in which an object in motion has stopped or an object has appeared in the scene (e.g., something thrown over a fence), and/or an object removal and insertion event where an object in a given scene has been removed or inserted.

Upon detection of one or more of these predetermined events based on the video signal, processor 230 generates a video alarm signal transmitted to control station 210, FIG. 1 via internet 214 when processor 230 dials the IP address of the central site. Processor 230, FIG. 2 also establishes a video signal link with either the appropriate satellite station 212, FIG. 1 or central station 200 upon the transmission of the video alarm signal according to a predetermined protocol. Typically, the video signal link is established with the satellite station unless a link cannot be established with a given satellite station in which case the video link is established between processor 230 and central station 210, FIG. 1. Or, the opposite could be true: the predetermined protocol could be to establish a video signal link with the central station unless such a link cannot be establish in which case the video link is established between processor 230 and a satellite station. The predetermined protocol may be based on the time of day. For example, during the normal working hours of 8-5, processor 230 could be programmed to establish a video link with its associated satellite station and then during off hours to establish the video link with central station 210.

Typically also associated with sites security system 220, FIG. 3 is monitor 240 allowing security personnel on site to view the output from cameras 222 as required. Signals from the various sensing devices are routed to alarm panel 242 connected to processor 230 via RS 232 connection 244. Concentrator panel 242 is also connected to relays in order trigger in action such as turning on or off various lights or locking various doors. Two-way loud speakers 246 strategically placed throughout the site are connected to audio switcher 248 connected via audio line 250 to audio amplifier 252 itself connected to processor 230 via codec 226. In this way, audio signals can be synchronized with the video signals. Keypad 252 allows an onsite operator to digitally control the pan, tilt, and zoom functions of video cameras 222. Audio switcher 248 is connected the two-way speakerphone 258 for local security personal. Processor 230 may also be connected to a site's existing alarm subsystem 260. The central station is also able to control all of the above functions.

The other primary functions of site security system 220 include providing automated transmission of alarm information (video, audio data) in real time over internet protocol networks to the designated central station as discussed above. Each customer site security system preferably supports full duplex video, audio, and data transmission and can be switched in control automatically or manually by the central station through TCP/IP links allowing the central station operator to have full control of a remote site. Each site security system can be connected to more than one central monitoring station. A control module of processor 230 is designed to interface with any existing or required CCTV system and allows the user to view, control real time events, and record video utilizing a graphical user interface. From the application screen presented on monitor 240, the user can access the resources and tools necessary to facilitate video management. An alarm module of processor 230 enables the viewing of live and/or recorded video of alarm events without interrupting the current recording process. Alarm video is stored for easy recall using the same control as used to review video thus simplifying the user interface. The alarm module also processes signals received from wired or wireless sensory devices together that with the associated video and audio signals. The preferred alarm module also includes a watch dog timer to ensure continuous non-stop operation.

Processor 230 also includes an interactive videoconferencing and multicast module that converges one-to-many streaming video with two-way interactive videoconferencing. This feature allows the site security system to deliver two solutions in a single package and users can switch between these two modes of communication. Finally, an administrator module of processor 230 is configured to manage system functions, security, user access and the set up and customization of the system at a particular site. The communication interface between processor 230 and the central station and the satellite station is based on an IP and/or an ISDN link and provides bandwidth management to ensure that interactive video applications do not saturate the network. This communication infrastructure also provides the best video and audio quality at a given data rate. Processor 230 is able to detect a network failure and switch the transmission automatically from an IP to an ISDN link as necessary. Fiber optic networks can be utilized in a network ring or daisy-chain topology. An electronic map of the site includes the location of the cameras and the sensors marked electronically. This map is loaded on the site processor during system installation. When an alert is generated by the video event detection program or by a sensor, the site map will be automatically displayed on a display at the satellite station and will highlight the location of the camera or the sensor that generated the alarm. This will allow the satellite operator to better control the site.

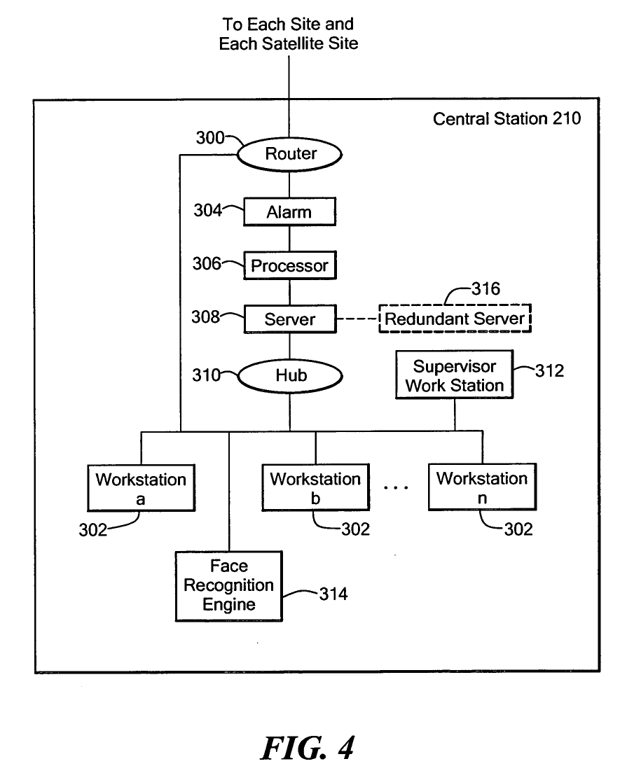

FIG. 4 describes an exemplary central station 210. Router 300 routes any received video signals to one or more workstations 302. Router 302 also routs data and audio signals received to one or more of the workstations 302. Received video alarm signals are routed to alarm receiver 304 and signal processor 306 is configured to associate each alarm signal with a particular site. Server 308 in turn is configured to associate the video alarm signal with a particular satellite station and to forward the video alarm signal to the appropriate satellite station in response. Workstations 302 are connected to each other by a network and to server 308 by hub 310. The network may include supervisor workstation 312 configured to route video alarm signals (and any received video signals and data and audio signals) to workstations 302 based on availability. Workstation 314 may include a face recognition engine 314 if desired. Redundant server 316 may also be provided. Each workstation 302 typically includes a personal computer with a head set and a speaker and each workstation is capable of communicating with processor 230, FIG. 3 at the customer's site to control video cameras 222, trigger various relays via concentrator panel 242, communicate via two-way speakers 246, and/or receive recorded video signals from digital video recorder 224.

Each satellite station 212, FIG. 2 is typically configured the same as a workstation 302, FIG. 4 of central station 210. In this way, central station 210 manages the accounts of all customer sites but each satellite station is directly responsible for servicing only the sites associated with it as dictated by central station 210. Workstations 302 of central station 210 include video decompression devices known in the art for decompressing the compressed video signal transmitted via the internet by processor 230.

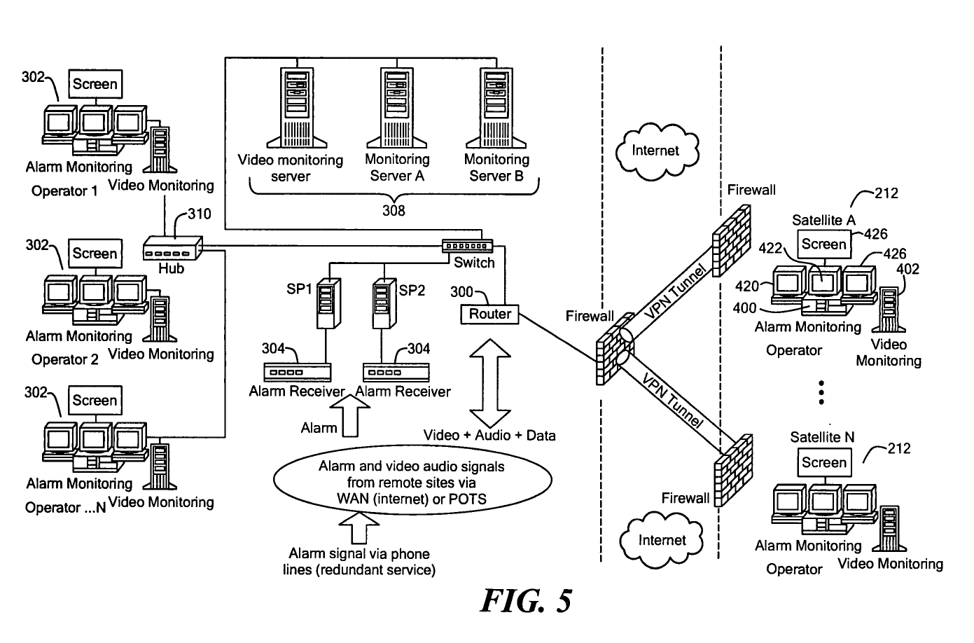

Each satellite station 212, FIG. 5 mirrors a complete central station operator console. This way, the operator at the satellite becomes an extension of the main control center, 210. Each satellite station 212 typically includes two workstations (computers) 400 and 402 that connect to the network and project information received over the network on four monitors. The monitors are situated in front of the operator. The displays control video and audio alerts from the site. Display 420 includes all the controls required to manage the site once an alert has been received from the site. Display 420, for example allows remote movement of PTZ cameras, activates two-way audio channels, opens or closes lights, doors at site, can view live image from any camera at all times. This display also projects an electronic site map with the highlighted location of the camera or sensor that generated the alarm. Display 422 displays the alarm status. This includes all the information that defines the site, points of contact and action menus to deal with the alarm. Display 424 displays video clips of the alarm and allows playback and review of video prior, during and after the video alarm. Display 426 is a large display that project a high resolution image of the live video from the site.

The interaction between the central station 210, satellite stations 212, and the site is as follows. The customer site is programmed to route live video and audio of the alert to the appropriate satellite. In case the satellite does not respond the video and audio are routed to the central station or another satellite which serve as backup. The notification that an alarm has occurred is sent in all cases directly to the central station. This is a data stream that informs the central station that an alarm of any kind has occurred, video alarm or alarm from sensors (notion detectors, door contacts). This alarm information is then routed from the central station to the relevant satellite and is displayed on a monitor. The information remains stored centrally for activity management purposes and report generation.

The subject invention thus features three primary communication channels. The first communication channel is between site security system processor 230, FIG. 3 and a central station workstation 302, FIG. 4 via internet 214, FIG. 2 for transmitting alarm signals, video signals, and video event signals from customer site 200 to a central workstation 302, FIG. 4. This channel provides video signal backup and alarm and event logging. The second communication channel is between site processor 230, FIG. 3 and the workstation of the appropriate satellite station 212, FIG. 2 for transmitting video signals from the site to a satellite workstation via internet 214, FIG. 2. The second communication channel thus provides geographically proximate customer service. The third communication channel is between central station 210, FIG. 4 and each satellite station 212, FIG. 2 for transmitting alarm signals and video event signals to the appropriate satellite workstation via internet 214, FIG. 2. In this way, any workstation of the central station and/or a workstation of a satellite station can control or functionally take the place of customer site processor 230, FIG. 3. There are may be additional data links between processor 230, FIG. 3 and the central station 210 as shown in FIG. 2 including ISDN links and “plain old telephone” or POT links.

It is also possible that a satellite station 212 may be physically located at a given site 200 and the site security system and/or the satellite station may be mobile (e.g., out fitted within a van or other vehicle). Central station 210 may include a video recorder such as digital video recorder 224 of customer site security system 220, FIG. 3. A typical central station allows monitoring in real time of a large number of remote sites achieved through a video event que, interactive mapping features, pop-up dispatch instructions, and image capture and e-mail capabilities. The control module of server 208, FIG. 4 allows operators at workstations 302 to monitor and record live events at remote sites. Using the control module, the operator is able to initiate a connection to any site processor and receive real time live streaming video up to 30 frames per second at SIF resolution. The central station operator is also able to initiate an intercom connection with any site or to respond to an intercom connection from any site. Finally, the operator is also able to activate a digital output in any customer site which could be used, for example, for remote door locking/unlocking at the remote site. Thus, a typical central station includes a video codec and a video recorder the same as the codec 226 and recorder 224 of site security system 220, FIG. 3.

Once an alarm is generated by the video event detection software operating on processor 230, FIG. 3 at a customer's site, a real time automated connection is established with the designated central station 210, FIG. 2. The video, audio, and data signals received are displayed on the operator's workstation 302 enabling the operator to take full control of the site. In the case of multiple alarms, the alarm events will roll over to the next available operator's control and mapping module according to the configuration of supervisor workstation 312. Each operator has a number of options that can be taken such as sending an alarm video to multiple security personnel either by wire or wirelessly, create a real time two-way video/audio connection with the customer site or with other security personnel, control PTZ cameras to view multiple cameras on a split screen, to e-mail information to security personnel including video snap shots and to create video clips of the alarm event.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

1. A video monitoring system for a plurality of sites, the system comprising:
a site security system located at each site, the site security system including:
one or more video cameras each outputting a video signal, and
a processor configured to:
receive a video signal from each camera,
detect predetermined events based on the video signal,
generate a video alarm signal upon the detection of an event,
transmit the video alarm signal to a central station, and
establish a video signal link either with the central station or one of a plurality of satellite stations according to a predetermined protocol upon the transmission of a video alarm signal;
the central station including:
a router for routing any received video signal to one or more workstations and for routing the video alarm signal to a server configured to associate the video alarm signal with a said satellite station and to forward the video alarm signal to the satellite station;
the satellite station including a workstation configured to receive a video alarm signal from the central station and to receive a video signal from the site security system.

2. The system of claim 1 in which the site security system further includes a digital video recorder responsive to the video signal for recording the video signal.

3. The system of claim 1 in which the site security system further includes a video compression device for compressing the digital video signal and workstations of the central station include a video decompression device for decompressing the video signal.

4. The system of claim 1 in which the site security system further includes one or more sensing devices connected to the processor and wherein the processor is configured to generate an alarm signal in response to the sensing devices and to transmit the alarm signal to the central station server via the router.

5. The system of claim 4 in which the site security system further includes an alarm system interconnected with the central station.

6. The system of claim 5 in which the alarm system is configured to send predetermined alarm signals to the processor of the site security system for transmission to the central station.

7. The system of claim 1 in which the site security system further includes one or more two-way speakers connected to the processor.

8. The system of claim 7 in which the processor is configured to transmit audio signals to the central station and the router of the central station is configured to route the audio signals to one or more of the workstations of the central station.

9. The system of claim 1 in which the processor of the site security system is configured to transmit the video alarm signal to the central station and to establish the video signal link according to an internet protocol.

10. The system of claim 9 further including additional data links between the processor of the site security system and the central station.

11. The system of claim 1 in which the central station further includes an alarm receiver for receiving alarm signals.

12. The system of claim 11 in which the central station further includes a signal processor responsive to the alarm receiver for associating alarm signals with particular sites.

13. The system of claim 1 in which the workstations of the central station are connected to the router and the server by a network.

14. The system of claim 13 in which one said workstation is configured as a supervisor station and programmed to route the video alarm signal and the video signal to another workstation based on availability.

15. The system of claim 13 in which a said workstation includes a face recognition engine responsive to the video signal.

16. The system of claim 13 in which selected workstations are configured to communicate with the site security system processor via the server of the central station to perform at least one action.

17. The system of claim 16 in which a said action is controlling a video camera.

18. The system of claim 16 in which a said action is triggering a relay.

19. The system of claim 16 in which a said action is communicating via a speaker.

20. The system of claim 16 in which a said action is receiving a recorded video signals.

21. The system of claim 1 in which a said satellite station is located at the site.

22. The system of claim 1 in which a said satellite station is regionally associated with a plurality of sites.

23. The system of claim 1 in which the predetermined protocol is to establish the video signal link with a satellite station during a first time period and to establish the video signal link with the central station during a second time period.

24. The system of claim 1 in which the predetermined protocol is to establish the video signal link with a satellite station unless said link cannot be established and to then in response establish the video signal link with the central station.

25. The system of claim 1 in which the predetermined protocol is to establish the video signal link with the central station unless said link cannot be established and to then in response to establish the video signal link with the satellite station.

26. The system of claim 1 in which the central station is UL certified.

27. The system of claim 1 in which further including a map of the site associated with the processor of the site security system and/or a workstation of the central station and/or a satellite station for pinpointing the location of a video alarm signal.

28. The system of claim 1 in which the site security system is mobile.

29. The system of claim 1 in which a said satellite station is mobile.

30. The system of claim 1 in which the central station includes a video recorder responsive to the video signal.

31. A video monitoring system for a plurality of sites, the system comprising:
a site security system located at each site including a processor configured to transmit video signals, alarm signals, and video event signals;
a central station including at least one workstation;
at least one satellite station including a workstation;
a first communication channel between the site security system processor and the central station workstation for transmitting alarm signals, video signals, and video event signals from the site to the central station workstation;
a second communication channel between the site processor and the satellite station workstation for transmitting video signals from the site to the satellite station workstation; and
a third communication channel between the central station and the satellite station for transmitting alarm signals and video event signals to the satellite station workstation.

32. The system of claim 31 in which each communication channel includes the internet.

33. The system of claim 32 in which the first communication channel further includes one or more additional data links between the site and the central station.

34. The system of claim 31 in which the central station workstation is configured to control the processor of the site security system via the first communication link.

35. The system of claim 31 in which the satellite station workstation is configured to control the processor of the site security system via the second communication channel.

36. A method of remotely monitoring a site, the method comprising:
receiving a video signal from cameras located at the site, detecting predetermined events based on the video signal, generating a video alarm signal upon the detection of an event, and transmitting the video alarm signal to a central station;
establishing a video signal link either with the central station or one of a plurality of satellite stations according to a predetermined protocol upon the transmission of a video alarm signal;
routing any received video signal to one or more central station workstations and routing the video alarm signal to a server configured to associate the video alarm signal with a satellite station and to forward the video alarm signal to the satellite station; and
receiving at the satellite station the video alarm signal from the central station and receiving the video signal from the site.

37. The method of claim 36 further including recording the video signal at the site.

38. The method of claim 36 further including compressing the video signal at the site and decompressing the video signal at the central station.

39. The method of claim 36 in which the site generates an alarm signal in response to sensing devices and transmits the alarm signal to the central station server.

40. The method of claim 36 in which the site transmits audio signals to the central station.

41. The method of claim 36 in which the site transmits the video alarm signal to the central station and establishes the video signal link according to an internet protocol.

42. The method of claim 41 further including additional data links between the processor of the site security system and the central station.

43. The method of claim 48 further including configuring one said workstation as a supervisor station programmed to route the video alarm signal and the video signal to another workstation based on availability.

44. The method of claim 36 in which the predetermined protocol is to establish the video signal link with a satellite station during a first time period and to establish the video signal link with the central station during a second time period.

45. The method of claim 36 in which the predetermined protocol is to establish the video signal link with a satellite station unless said link cannot be established and to then establish the video signal link with the central station.

46. The method of claim 36 in which the predetermined protocol is to establish the video signal link with the central station unless said link cannot be established and to then establish the video signal link with the satellite station.
